(19) United States
(12) Patent Application Publication
(10) Pub. No.: US 2013/0125191 A1
(43) Pub. Date: May 16, 2013

(54) ELECTRONIC APPARATUS AND METHOD FOR USING FLAT PANEL DISPLAY

(71) Applicant: Shin-Jie Chen, Taipei City (TW)

(72) Inventor: Shin-Jie Chen, Taipei City (TW)

(73) Assignee: INVENTEC CORPORATION, Taipei City (TW)

(21) Appl. No.: 13/326,104

(22) Filed: Dec. 14, 2011

(30) Foreign Application Priority Data
Nov. 16, 2011 (TW) 100141859

(51) Int. Cl. H04N 7/173; H04N 7/16

(52) U.S. Cl. 725/117; 725/151

(57) ABSTRACT

An electronic apparatus and a method for using a flat panel display are provided. The electronic apparatus includes a host and a flat panel display. The host and the flat panel display include a processing unit respectively. The flat panel display further includes a display module and a controlling switch, so that the controlling switch determines whether the flat panel display is connected with the host. When the flat panel display is connected with the host, the display module receives a first video signal transmitted from the host. When the flat panel display is detached from the host, the display module receives a second video signal from the flat panel display.

### CROSS-REFERENCE TO RELATED APPLICATION

This application claims the priority benefit of Taiwan application serial no. 100141859, filed on Nov. 16, 2011. The entirety of the above-mentioned patent application is hereby incorporated by reference herein and made a part of this specification.

### BACKGROUND OF THE INVENTION

1. Field of the Invention

The present invention relates to an electronic apparatus, and more particularly relates to an electronic apparatus having a flat panel display detachably connected with a host, and a method for using a flat panel display.

2. Description of Related Art

Since the electronic technology is rapidly advancing, all sorts of electronic products such as notebook computers pursuit the humanization design of portability. With the progress of technology, a tablet computer is proposed. The tablet computer is a small-sized portable personal computer, and utilizes a touch screen as a basic input apparatus. The tablet computer is featured by a large-scale touch flat panel display possessing both image output and contact input functions, and allows the user to operate with a stylus pen, digital pen or finger instead of the conventional keyboard or mouse. However, the tablet computer has a limited performance of the hardware resource limited by the volume.

### SUMMARY OF THE INVENTION

The present invention is directed to an electronic apparatus, having a flat panel display detachably connected with a host.

The present invention is also directed to a method for using a flat panel display, so that when a flat panel display is connected with a host, the flat panel display serves as output equipment of the host, and when the flat panel display is detached from the host, the flat panel display may operate independently as another computer system.

The present invention provides an electronic apparatus, which includes a host and a flat panel display. The flat panel display is detachably connected with the host. The host includes a first processing unit, a first connection terminal and a trigger portion. The first connection terminal is coupled to the first processing unit, and used to transmit a first video signal. The flat panel display includes a second processing unit, a second connection terminal, a controlling switch and a display module. The second processing unit is coupled to the controlling switch and the display module, and the display module is coupled to the second connection terminal. When the flat panel display is connected with the host, the second connection terminal is connected with the first connection terminal. The second processing unit is used to transmit a second video signal. The controlling switch is used to control whether to disable the second video signal or not. When the host is connected with the flat panel display, the trigger portion is used to trigger the controlling switch to disable the second video signal, so that the display module receives the first video signal. When the host is detached from the flat panel display, the controlling switch enables the second video signal, so that the display module receives the second video signal.

In an embodiment of the present invention, the flat panel display further includes a touch module, coupled to the second processing unit.

In an embodiment of the present invention, the flat panel display further includes a power supply device and a power control unit. The power supply device is coupled to the second processing unit, and used to supply power to the second processing unit. The power control unit is coupled to the controlling switch and the power supply device, and used to drive the power supply device, so that the power supply device supplies power to the second processing unit. When the flat panel display is connected with the host, the controlling switch disables the power control unit.

In an embodiment of the present invention, the power control unit includes a transistor switch and a power button. The transistor switch is coupled to the controlling switch and the power supply device, and the power button is coupled to the transistor switch. When the flat panel display is connected with the host, the controlling switch outputs a control signal to the transistor switch, so as to turn off the transistor switch, thereby disabling the power button.

In an embodiment of the present invention, the flat panel display further includes a linking unit, coupled to the second processing unit, and used to link to the Internet. When the flat panel display is connected with the host, the flat panel display uploads processing data of the second processing unit to a cloud database through the linking unit. When the flat panel display is detached from the host, the flat panel display downloads the processing data of the second processing unit from the cloud database through the linking unit.

In an embodiment of the present invention, when the flat panel display is connected with the host, the controlling switch outputs a control signal, so that a backlight enable signal changes from a first logic level to a second logic level, thereby disabling the second video signal.

In an embodiment of the present invention, when the host is detached from the flat panel display, the first connection terminal changes to the first logic level, and when the host is connected with the flat panel display, the first connection terminal changes to the second logic level.

In an embodiment of the present invention, when the first processing unit detects that the first connection terminal changes from the first logic level to the second logic level, the first connection terminal outputs the first video signal to the second connection terminal. When the first processing unit detects that the first connection terminal changes from the second logic level to the first logic level, the processing data of the first processing unit is stored to a storage unit of the host or the cloud database.

The present invention also provides a method for using a flat panel display. The flat panel display is detachably connected with a host. Here, the host includes a first processing unit, and the flat panel display includes a second processing unit and a display module. The flat panel display is disposed with a controlling switch, so as to determine whether the flat panel display is connected with the host through the controlling switch. When the host is detached from the flat panel display, the display module receives a second video signal transmitted by the second processing unit. On the other hand, when the host is connected with the flat panel display, the controlling switch disables the second video signal, so that the display module receives a first video signal transmitted by the first processing unit.

In an embodiment of the present invention, when the flat panel display is connected with the host, the controlling switch outputs a control signal to disable the power control unit of the flat panel display; the processing data of the second processing unit is uploaded to a cloud database, and the flat panel display is switched from a start-up mode to a standby mode. When the flat panel display is detached from the host, a second video signal of the flat panel display is enabled through the controlling switch, and the processing data is downloaded to the flat panel display from the cloud database. In addition, when the flat panel display is detached from the host, after first preset time, the host is switched from the start-up mode to the standby mode, and after second preset time, the host is powered off.

In view of the above, in the electronic apparatus, the flat panel display is detachably connected with the host. When the flat panel display is connected with the host, the flat panel display serves as video output equipment of the host. When the flat panel display is detached from the host, the flat panel display may operate independently as a tablet computer.

In order to make the aforementioned features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block view of an electronic apparatus according to a first embodiment of the present invention.

FIG. 2 is a flow chart of a method for using a flat panel display according to the first embodiment of the present invention.

FIG. 3 is a block view of an electronic apparatus according to a second embodiment of the present invention.

FIG. 4 is a flow chart of a method for using a flat panel display according to the second embodiment of the present invention in a situation that a host is detached from the flat panel display.

FIG. 5 is a flow chart of a method for using the host according to the second embodiment of the present invention in the situation that the host is detached from the flat panel display.

FIG. 6 is a flow chart of the method for using the flat panel display according to the second embodiment of the present invention in the situation that the host is connected with the flat panel display.

FIG. 7 is a flow chart of the method for using the host according to the second embodiment of the present invention in the situation that the host is connected with the flat panel display.

FIG. 8 is a schematic profile view of an electronic apparatus according to a third embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

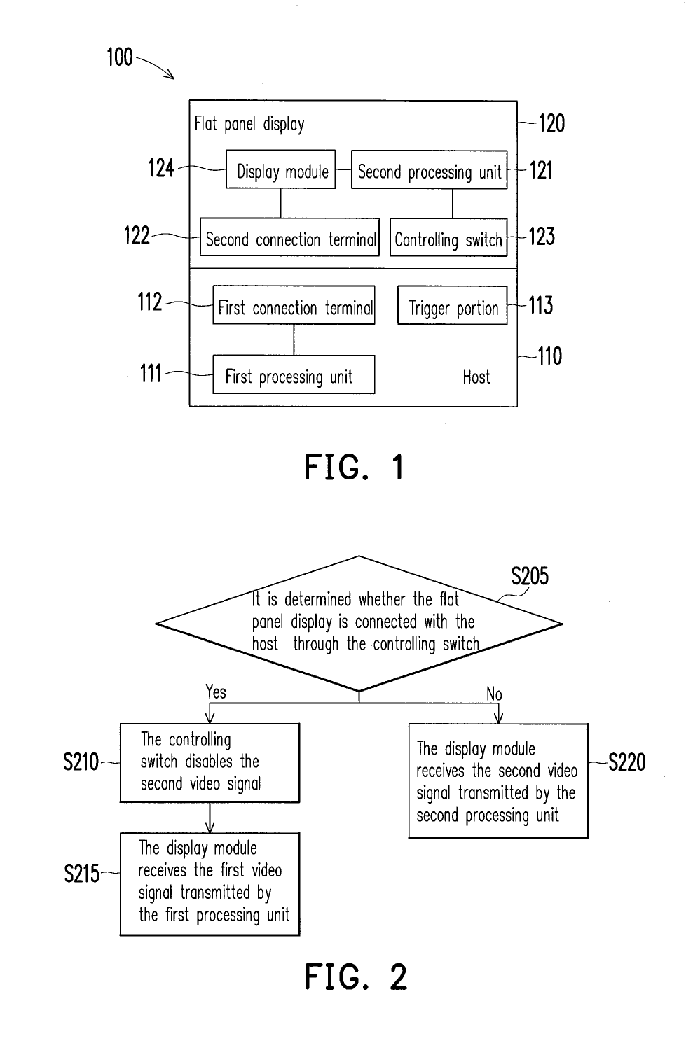

FIG. 1 is a block view of an electronic apparatus according to a first embodiment of the present invention. Referring to FIG. 1, the electronic apparatus 100 includes a host 110 and a flat panel display 120. The flat panel display 120 is detachably connected with the host 110. The host 110 includes a first processing unit 111, a first connection terminal 112 and a trigger portion 113. The flat panel display 120 includes a second processing unit 121, a second connection terminal 122, a controlling switch 123 and a display module 124. When the host 110 is connected with the flat panel display 120, the first connection terminal 112 is connected with the second connection terminal 122.

In the host 110, the trigger portion 113 is used to trigger the controlling switch 123 when the host 110 is connected with the flat panel display 120. The first processing unit 111 is, for example, a central processing unit (CPU), which is coupled to the first connection terminal 112 and used to transmit the first video signal to the first connection terminal 112. For example, the host 110 includes a display chip (not shown). The display chip is coupled between the first processing unit 111 and the first connection terminal 112, so as to generate the first video signal. Alternatively, the first processing unit 111 may be integrated with the display chip, thereby generating the first video signal.

In the flat panel display 120, the second processing unit 121 is coupled to the controlling switch 123 and the display module 124. The second connection terminal 122 is coupled to the display module 124. The second processing unit 121 is, for example, a microprocessor, for transmitting a second video signal to the display module 124. The flat panel display 120 further includes a display chip (not shown) to generate the second video signal. The display chip is coupled between the second processing unit 121 and the display module 124. Alternatively, the display chip may be integrated with the second processing unit 121, thereby generating the second video signal.

When the flat panel display 120 is connected with the host 110, the second connection terminal 122 receives the first video signal from the first connection terminal 112. Furthermore, when the flat panel display 120 is connected with the host 110, the second connection terminal 122 is connected with the first connection terminal 112, so as to receive the first video signal from the first connection terminal 112.

The controlling switch 123 is used to control whether to disable the second video signal or not. In details, when the flat panel display 120 is connected with the host 110, the controlling switch 123 disables the second video signal. When the flat panel display 120 is detached from the host 110, the controlling switch 123 enables the second video signal.

The display module 124 is, for example, a liquid crystal display module (LCM) or a light emitting diode (LED) display module or the like, for receiving the first video signal transmitted by the first processing unit 111 or receiving the second video signal transmitted by the second processing unit 121. The controlling switch 123 determines that the display module 124 receives the first video signal or the second video signal. Here, the first video signal is, for example, a high definition multimedia interface (HDMI) signal, and the second video signal is, for example, a low voltage differential signaling (LVDS).

The steps of using the flat panel display 220 are illustrated in combination with the electronic apparatus 100. FIG. 2 is a flow chart of a method for using a flat panel display according to the first embodiment of the present invention. Referring to FIG. 1 and FIG. 2 together, in step S205, it is determined whether the flat panel display 120 is connected with the host 110 through the controlling switch 123.

In this embodiment, the controlling switch 123 in the flat panel display 120 is, for example, a lid switch, which is one sort of the reed switch. The trigger portion 113 of the host 110 is, for example, a strong magnet. The controlling switch 123 and the trigger portion 113 are configured on the corresponding positions, so that when the flat panel display 120 is connected with the host 110, the trigger portion 113 is connected with the controlling switch 123, so as to trigger the controlling switch 123.

For example, when the host 110 is connected with the flat panel display 120, the controlling switch 123 is triggered by the trigger portion 113 to output a control signal, so that the backlight enable signal changes from the first logic level (for example, a logic high level) to the second logic level (for example, a logic low level). Furthermore, when the trigger portion 113 (for example, a magnet) gets close to the controlling switch 123, the control signal is drawn to the logic low level, so that the backlight enable signal is also drawn to the logic low level (which indicates that the backlight signal is turned off), thereby disabling the second video signal.

For example, the flat panel display 120 further includes an embedded controller, system firmware and a chip set. Here, the embedded controller is, for example, a keyboard controller (KBC), the system firmware is, for example, a basic input output system (BIOS), and the chip set is, for example, a platform controller hub (PCH). The control signal is transmitted to the KBC. When the control signal is drawn to the logic low level, the backlight enable signal is drawn to the logic low level. Thereafter, the BIOS is notified by the KBC, and then the BIOS notifies the PCH of disabling the second video signal.

When the controlling switch 123 obtains that the flat panel display 120 is connected with the host 110, in step S210, the controlling switch 123 disables the second video signal. Since the second connection terminal 122 is connected with the first connection terminal 112, in step S215, the display module 124 receives the first video signal transmitted by the first processing unit 111.

On the other hand, when the controlling switch 123 detects that the flat panel display 120 is detached from the host 110, in step S220, the display module 124 receives the second video signal transmitted by the second processing unit 121.

In other words, when the host 110 is connected with the flat panel display 120, the controlling switch 123 disables the second video signal, so that the display module 124 receives the first video signal from the first connection terminal 112 through the second connection terminal 122. On the other hand, when the host 110 is detached from the flat panel display 120, the controlling switch 123 enables the second video signal, so that the display module 124 receives the second video signal.

For example, the host 210 is installed with the Microsoft Windows system, and the flat panel display 220 is installed with the Android operating system. When the flat panel display 220 is connected with the host 210, a frame displayed by the flat panel display 220 is the Microsoft Windows system. When the flat panel display 220 is detached from the host 210, a frame displayed by the flat panel display 220 is the Android operating system.

### Second Embodiment

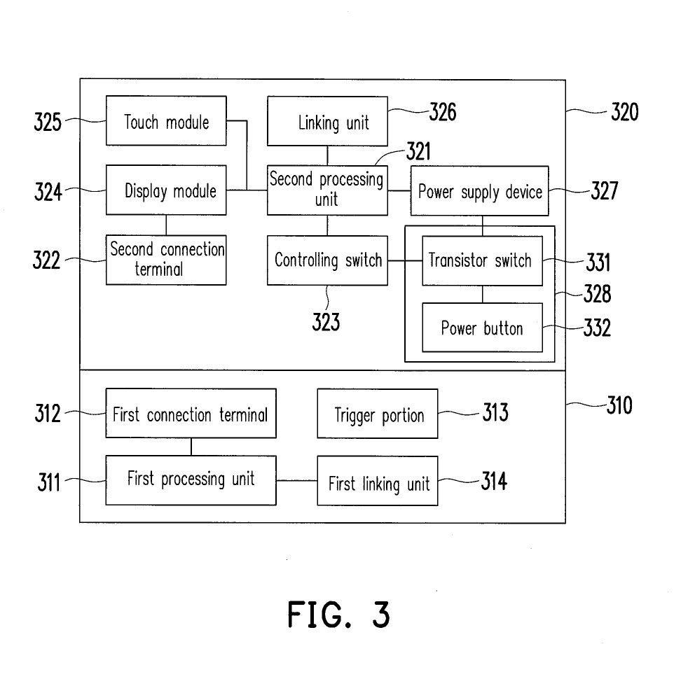

FIG. 3 is a block view of an electronic apparatus according to the second embodiment of the present invention. Referring to FIG. 3, the electronic apparatus 300 includes a host 310 and a flat panel display 320. The flat panel display 320 is detachably connected with the host 310. In this embodiment, the host 310 includes a first processing unit 311, a first connection terminal 312, a trigger portion 313 and a first linking unit 314. The flat panel display 320 includes a second processing unit 321, a second connection terminal 322, a controlling switch 323 and a display module 324, and further includes a touch module 325, a linking unit 326, a power supply device 327 and a power control unit 328. The power control unit 328 includes a transistor switch 331 and a power button 332.

When the host 310 is connected with the flat panel display 320, the first connection terminal 312 is connected with the second connection terminal 322, and the trigger portion 313 is also connected with the controlling switch 323, so as to trigger the controlling switch 323.

In this embodiment, the first processing unit 311, the first connection terminal 312 and the trigger portion 313 of the host 310, and the second processing unit 321, the second connection terminal 322, the controlling switch 323 and the display module 324 of the flat panel display 320 respectively have identical or similar functions of the components of the host 110 and the flat panel display 120 in the first embodiment, so details will not be repeated herein again.

In this embodiment, the host 310 and the flat panel display 320 respectively have a first linking unit 314 and a second linking unit 326. The first linking unit 314 is coupled to the first processing unit 311, and the second linking unit 326 is coupled to the second processing unit 321, so that the host 310 and the flat panel display 320 are linked to the Internet.

In addition, in the flat panel display 320, the touch module 325 is coupled to the second processing unit 321, so that the flat panel display 320 has a touch function. The touch module 325 may also be integrated with the display module 324, so that the display module 324 has the touch function. Based on the induction principle, the touch module 325 may be capacitive, infrared-ray, ultrasound, resistive, electromagnetic or image sensitive or the like.

The power supply device 327 is coupled to the second processing unit 321 and the power control unit 328. The power supply device 327 is used to supply power to the second processing unit 321. The power control unit 328 is used to drive the power supply device 327, so that the power supply device 327 supplies power to the second processing unit 321. In this embodiment, the controlling switch 323 is coupled to the power control unit 328. When the host 310 is connected with the flat panel display 320, the controlling switch 323 disables the power control unit 328.

For example, the power control unit 328 includes a transistor switch 331 and a power button 332. The transistor switch 331 is coupled to the controlling switch 323, the power supply device 327 and the power button 332 respectively. When the flat panel display 320 is connected with the host 310, the trigger portion 313 triggers the controlling switch 323, so that the controlling switch 323 outputs a control signal to the transistor switch 331, so as to turn off the transistor switch 331, thereby disabling the power button 332. In other words, in the situation that the transistor switch 331 is turned off, no function is generated when pressing the power button 332. For example, when the host 310 is connected with the flat panel display 320, the control signal is drawn to the logic low level, so that the transistor switch 331 is not conducted. Accordingly, no action is generated regardless of pressing the power button 332 in any way.

In this manner, when the host 310 is connected with the flat panel display 320, provided that both the host 310 and are flat panel display 320 are in a power-off state, if the user presses the power button 332 of the flat panel display 320, the flat panel display 320 is not started up. In other words, after the host 310 is detached from the flat panel display 320, the power button 332 after being pressed takes actions. Accordingly, in the situation that both the host 310 and the flat panel display 320 are in the power-off state, when the user actuates the power button of the host 310 to make the host 310 to enter the start-up mode, the flat panel display 320 is regarded as video output equipment of the host 310.

Hereinafter, the operations of the host 310 and the flat panel display 320 in the situations that the host 310 is detached from and connected with the flat panel display 320 are illustrated.

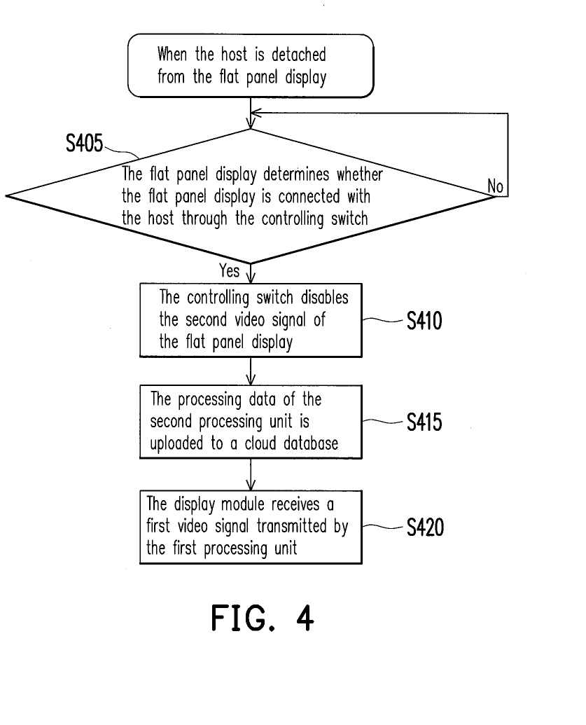

FIG. 4 is a flow chart of a method for using the flat panel display according to the second embodiment of the present invention in the situation that the host is detached from the flat panel display. Referring to FIG. 3 and FIG. 4 together, in the situation that the host 310 is detached from the flat panel display 320, in step S405, the flat panel display 320 determines whether the flat panel display 320 is connected with the host 310 through the controlling switch 323. If the flat panel display 320 is detected to be connected with the host 310, step S410 is executed. Otherwise, the flat panel display 320 is still detached from the host 310.

When the flat panel display 320 is connected with the host 310, in step S410, the controlling switch 323 disables the second video signal of the flat panel display 320. In step S415, the processing data of the second processing unit 321 is uploaded to a cloud database through the second linking unit 326. In addition, the flat panel display 320 is switched from the start-up mode to the standby mode. Here, step S410 and step S415 are not executed in orders. Step S415 may be firstly executed, and then step S410 is executed, or step S410 and step S415 may be executed at the same time. After the second video signal is disabled, in step S420, the display module 324 receives a first video signal transmitted by the first processing unit 311 through the second connection terminal 322.

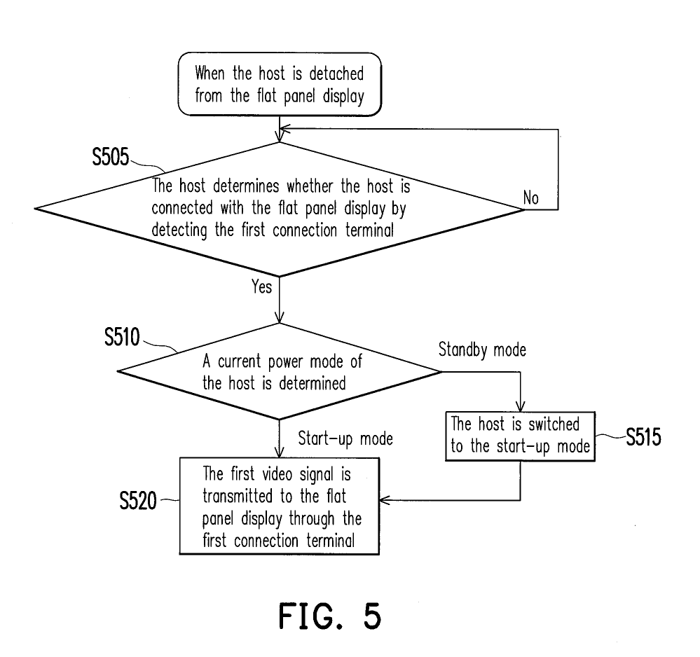

FIG. 5 is a flow chart of a method for using the host according to the second embodiment of the present invention in the situation that the host is detached from the flat panel display. Referring to FIG. 3 and FIG. 5 together, in the situation that the host 310 is detached from the flat panel display 320, in step S505, the host 310 determines whether the host 310 is connected with the flat panel display 320 by detecting the first connection terminal 312. If the host 310 is detected to be connected with the flat panel display 320, step S510 is executed. Otherwise, the host 310 is still detached from the flat panel display 320.

When the host 310 is connected with the flat panel display 320, in step S510, a current power mode of the host 310 is determined. When the host 310 is in the standby mode, step S515 is executed to switch the host 310 to the start-up mode. In the situation that the host 310 is in the start-up mode, step S520 is executed, the first video signal is transmitted to the flat panel display 320 through the first connection terminal 312.

In other words, in FIG. 4 and FIG. 5, when the host 310 changes to be connected with the flat panel display 320 from the state of being detached from the flat panel display 320, the flat panel display 320 automatically saves the processing data and uploads the processing data to the cloud database. Since the host 310 is connected with the flat panel display 320, the controlling switch 323 is triggered. The control signal is, for example, drawn to the logic low level, so the second video signal (for example, the LVDS signal) is disabled. The host 310 outputs the first video signal (for example, the HDMI signal) to the second connection terminal 322 through the first connection terminal 312. For the host 310, since the flat panel display 320 is connected with the host 310, the first connection terminal 312 (for example, the HDMI_HPD pin) of the host 310 is drawn to the logic low level, thereby obtaining that the host 310 is connected with the flat panel display 320, so as to transmit the first video signal to the flat panel display 320. If the host 310 is in the standby mode at the moment, the host 310 is switched to the start-up mode and then transmits the first video signal to the flat panel display 320.

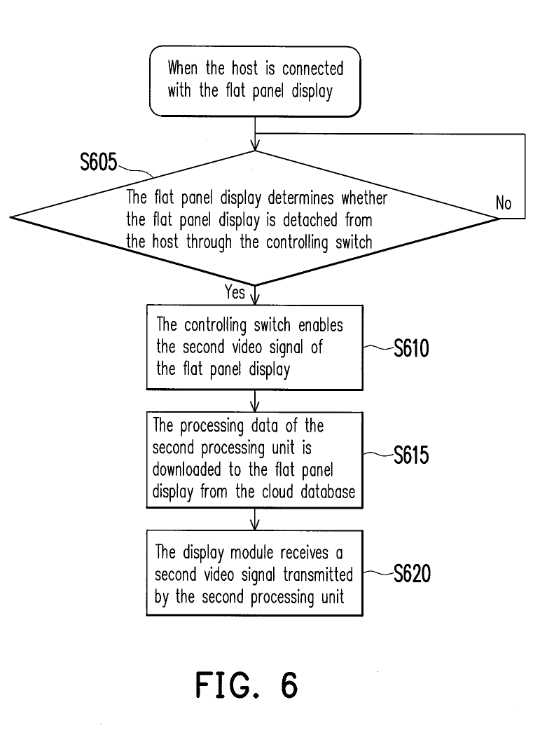

FIG. 6 is a flow chart of the method for using the flat panel display according to the second embodiment of the present invention in the situation that the host is connected with the flat panel display. Referring to FIG. 3 and FIG. 6 together, in the situation that the host 310 is connected with the flat panel display 320, in step S605, the flat panel display 320 determines whether the flat panel display 320 is detached from the host 310 through the controlling switch 323. If the flat panel display 320 is detected to be detached from the host 310, step S610 is executed. Otherwise, the flat panel display 320 is still connected with the host 310.

When the flat panel display 320 is detached from the host 310, in step S610, the flat panel display 320 enables the second video signal of the flat panel display 320 through the controlling switch 323. In step S615, the processing data of the second processing unit 321 is downloaded to the flat panel display 320 from the cloud database. Here, step S610 and step S615 are not executed in orders. Step S615 may be firstly executed, and then step S610 is executed, or step S610 and step S615 may be executed at the same time. Then, in step S620, the display module 324 may receive the second video signal transmitted by the second processing unit 321.

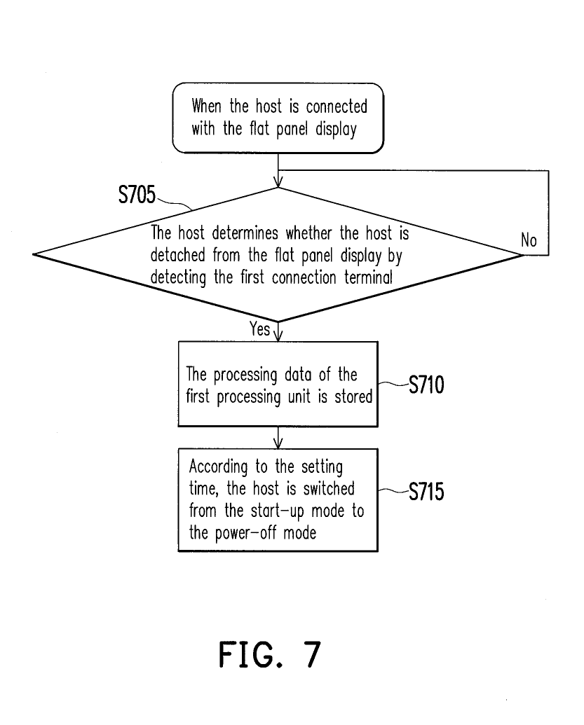

FIG. 7 is a flow chart of the method for using the host according to the second embodiment of the present invention in the situation that the host is connected with the flat panel display. Referring to FIG. 3 and FIG. 7 together, in the situation that the host 310 is connected with the flat panel display 320, in step S705, the host 310 determines whether the host 310 is detached from the flat panel display 320 by detecting the first connection terminal 312. If the host 310 is detected to be detached from the flat panel display 320, step S710 is executed. Otherwise, the host 310 is still connected with the flat panel display 320.

When the host 310 is detached from the flat panel display 320, in step S710, the processing data of the first processing unit 311 is stored. For example, the processing data of the first processing unit 311 may be stored in the storage unit of the host 310, or the processing data may be uploaded to the cloud database through the first linking unit 314. In step S715, according to the setting time, the host 310 is switched from the start-up mode to the power-off mode. Furthermore, after first preset time, the host 310 is switched from the start-up mode to the standby mode. After second preset time, the host 310 is automatically powered off.

For example, provided that the first connection terminal 312 is the HDMI_HPD pin, when the signal of the HDMI_HPD pin changes from the logic high level to the logic low level, the host 310 changes to be connected with the flat panel display 320 from the state of being detached from the flat panel display 320. On the other hand, when the signal of the HDMI_HPD pin changes from the logic low level to the logic high level, the host 310 changes to be detached from the flat panel display 320 from the state of being connected with the flat panel display 320.

When the host 310 is in the start-up state and is detached from the flat panel display 320, the signal of the first connection terminal 312 (for example, the HDMI_HPD pin) is at the logic high level, so the host 310 does not output the first video signal. When the signal of the HDMI_HPD pin is still at the logic high level after 10 minutes, the host 310 enters the standby mode. When the signal of the HDMI_HPD pin is still at logic high level after 20 minutes, the host 310 enters the power-off mode.

### Third Embodiment

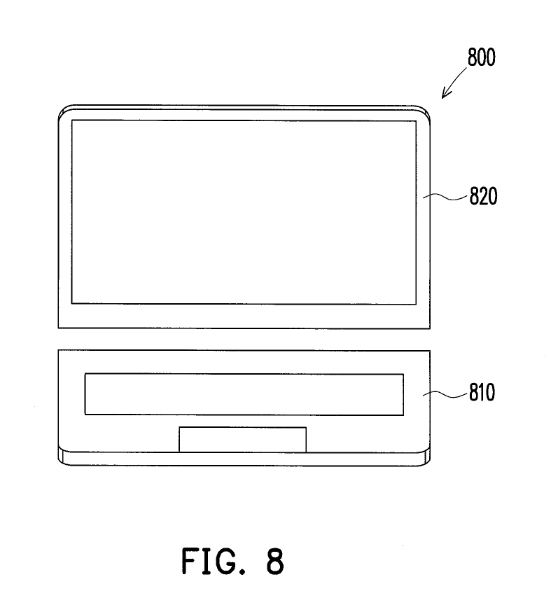

FIG. 8 is a schematic profile view of an electronic apparatus according to a third embodiment of the present invention. Referring to FIG. 8, in this embodiment, the electronic apparatus 800 is, for example, a notebook computer, which includes a host 810 and a flat panel display 820. Here, the components of the host 810 and the flat panel display 820 are respectively identical or similar to the host 110 and the flat panel display 120 in the first embodiment or the host 310 and the flat panel display 320 in the second embodiment, and the details will not be repeated herein again.

When the flat panel display 820 is connected with the host 810, which may be regarded as the notebook computer, the flat panel display 820 serves as video output equipment of the host 810. On the other hand, when the flat panel display 820 is detached from the host 810, since the flat panel display 820 also has the processing unit (for example, the second processing unit 121 of the flat panel display 120 and the second processing unit 321 of the flat panel display 320), the flat panel display 820 may be regarded as the independent tablet computer. Accordingly, the host 810 and the flat panel display 820 may run an operating system independently.

For example, the host 810 is installed with the Microsoft Windows system, and the flat panel display 820 is installed with the Android operating system. When the host 810 is connected with the flat panel display 820, the Android operating system installed in the flat panel display 820 enters a sleep mode, and now a frame of the flat panel display 820 is the Windows operating system of the host 810. When the host 810 is detached from the flat panel display 820, the frame of the flat panel display 820 is the Android operating system installed therein.

In view of the above, in the embodiment, the processing unit is disposed in host and the flat panel display of the electronic apparatus respectively, so as to install one operating system on the flat panel display and install another operating system on the host. When the host and the flat panel display are combined, the electronic apparatus may be regarded as one computer in the normal using state. Here, the flat panel display is one output apparatus, and is powered by the host. When the host and the flat panel display are separated, the flat panel display may also be regarded as the independent tablet computer. Accordingly, the flat panel display is detachably connected with the host, which enables the hardware resource of the host to support the operating system with higher resolution and performance. By plugging/detaching the flat panel display to/from the host, the electronic apparatus is further switched between two operating systems, thereby achieving the high performance and entertainment effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic apparatus, comprising:
a host, comprising:
a first processing unit, for transmitting a first video signal;
a first connection terminal, coupled to the first processing unit; and
a trigger portion; and
a flat panel display, detachably connected with the host, the flat panel display comprising:
a second connection terminal, wherein when the flat panel display is connected with the host, the second connection terminal is connected with the first connection terminal;
a second processing unit, for transmitting a second video signal;
a controlling switch, coupled to the second processing unit, and used to control whether to disable the second video signal or not; and
a display module, coupled to the second connection terminal and the second processing unit;
wherein when the host is connected with the flat panel display, the trigger portion triggers the controlling switch to disable the second video signal, so that the display module receives the first video signal; when the host is detached from the flat panel display, the controlling switch enables the second video signal, so that the display module receives the second video signal.

2. The electronic apparatus according to claim 1, wherein the flat panel display further comprises:
a power supply device, coupled to the second processing unit, and supplying power to the second processing unit; and
a power control unit, coupled to the controlling switch and the power supply device, and used to drive the power supply device;
wherein when the host is connected with the flat panel display, the controlling switch disables the power control unit, and the power control unit comprises a transistor switch and a power button, the transistor switch is coupled to the controlling switch and the power supply device, the power button is coupled to the transistor switch, when the flat panel display is connected with the host, the controlling switch outputs a control signal to the transistor switch, so as to turn off the transistor switch, thereby disabling the power button.

3. The electronic apparatus according to claim 1, wherein when the host is connected with the flat panel display, the controlling switch outputs a control signal, so that a backlight enable signal changes from a first logic level to a second logic level, thereby disabling the second video signal.

4. The electronic apparatus according to claim 1, wherein the flat panel display further comprises:
a linking unit, coupled to the second processing unit, and used to link to an Internet;
wherein when the flat panel display is connected with the host, the linking unit uploads processing data of the second processing unit to a cloud database; when the flat panel display is detached from the host, the linking unit downloads the processing data of the second processing unit from the cloud database.

5. The electronic apparatus according to claim 1, wherein when the host is detached from the flat panel display, the first connection terminal changes to a first logic level, when the host is connected with the flat panel display, the first connection terminal changes to a second logic level, when the first processing unit detects that the first connection terminal changes from the first logic level to the second logic level, the first connection terminal outputs the first video signal to the second connection terminal; when the first processing unit detects that the first connection terminal changes from the second logic level to the first logic level, processing data of the first processing unit is stored.

6. A method for using a flat panel display, wherein the flat panel display is detachably connected with a host, the host comprises a first processing unit, the flat panel display comprises a second processing unit and a display module, the method comprising:
determining, through a controlling switch, whether the flat panel display is connected with the host, wherein the controlling switch is disposed in the flat panel display;
when the host is detached from the flat panel display, the display module receiving a second video signal transmitted by the second processing unit; and
when the host is connected with the flat panel display, the controlling switch disabling the second video signal, so that the display module receives a first video signal transmitted by the first processing unit from the host.

7. The method for using a flat panel display according to claim 6, wherein when the host is connected with the flat panel display, the method further comprises:
the controlling switch outputting a control signal to disable a power control unit of the flat panel display.

8. The method for using a flat panel display according to claim 6, wherein when the flat panel display is connected with the host, the method further comprises:
uploading processing data of the second processing unit to a cloud database; and
switching the flat panel display from a start-up mode to a standby mode.

9. The method for using a flat panel display according to claim 8, wherein when the flat panel display is detached from the host, the method further comprises:
enabling, by the controlling switch, the second video signal of the flat panel display; and
downloading the processing data to the flat panel display from the cloud database.

10. The method for using a flat panel display according to claim 6, wherein when the flat panel display is detached from the host, the method further comprises:
after first preset time, switching the host from a start-up mode to a standby mode;
after second preset time, powering off the host.
